(19) United States
(12) Patent Application Publication
(10) Pub. No.: US 2026/0236583 A1
(43) Pub. Date: Aug. 13, 2026

(54) SYSTEM AND METHOD FOR SECURING A FIRMWARE

(71) Applicant: Honeywell International Inc., Charlotte, NC (US)

(72) Inventors: Abinash Prusty, Bengaluru (IN); Amitsurjya Duttagupta, Noida (IN)

(21) Appl. No.: 19/050,135

(22) Filed: Feb. 11, 2025

(51) Int. Cl. G06F 21/57; G06F 21/60

(52) U.S. Cl. CPC G06F 21/572; G06F 21/602

(57) ABSTRACT

The disclosure relates to a system and method for securing firmware including generating a cryptographic package comprising a Root Certificate Authority (Root CA) certificate, an Intermediate Certificate Authority (ICA) certificate associated with the Root CA, and a signing key pair comprising a private and a public key. A signed firmware package is created by generating a cryptographic hash of the firmware, signing the hash with the private key to produce a digital signature, and packaging the firmware, digital signature, ICA certificate, and Root CA certificate. The signed firmware package is transmitted to a device, which verifies it by validating the digital signature, ICA certificate, and Root CA certificate to establish a chain of trust. The device authenticates the firmware using the digital signature and cryptographic hash. This method ensures secure, flexible, and robust firmware validation, resistant to changes in certificate authority structures or signing key generation processes.

### TECHNICAL FIELD

The present disclosure relates to firmware security. More specifically, the present disclosure relates to systems and methods for securing firmware using cryptographic techniques, including digital signatures, certificate chains, and regular expressions for validation.

### BACKGROUND

Firmware security is a critical aspect of maintaining the integrity and trustworthiness of embedded devices. Conventional methods for verifying firmware authenticity and integrity typically rely on static configurations of signing keys and certificate hierarchies. These methods lack flexibility to accommodate changes in the signing key generation process or the Intermediate Certificate Authority (ICA). Such inflexibility can lead to vulnerabilities, operational inefficiencies, and potential security risks, especially in dynamic environments requiring frequent updates.

Existing sign-verification techniques often focus solely on certificate chain validation, which is susceptible to lapses in robustness when new Intermediate Certificate Authorities (ICAs) are introduced or when existing ICAs are updated.

### SUMMARY

The present disclosure discloses a secure, flexible, and robust firmware verification system that can accommodate future technological changes while ensuring the authenticity and integrity of firmware updates.

According to an aspect of the disclosure, a method for securing firmware is disclosed. The method comprises generating a cryptographic package comprising a Root Certificate Authority (Root CA) certificate, an Intermediate Certificate Authority (ICA) certificate associated with the Root CA, and a signing key pair comprising a private key and a corresponding public key. The method further comprises creating a signed firmware package based on the cryptographic package and the firmware to be installed on a device. Creating the signed firmware package comprises generating a cryptographic hash of the firmware, signing the cryptographic hash based on the private key to generate a digital signature, and packaging the firmware, the digital signature, the ICA certificate, and the Root CA certificate into the signed firmware package.

The method further comprises sending the signed firmware package to the device and verifying the signed firmware package by the device. Verifying the signed firmware package by the device comprises validating the digital signature, the ICA certificate, and the Root CA certificate to establish a chain of trust and authenticating the firmware using the digital signature and the cryptographic hash.

In some embodiments, generating the cryptographic package comprises generating the Root CA certificate to serve as a trust anchor, generating the ICA certificate signed by the Root CA certificate, and creating the signing key pair comprising the private key for signing operations and the corresponding public key for verification.

In some embodiments, the cryptographic hash is generated based on a Secure Hash Algorithm-256 (SHA-256).

In some embodiments, validating the digital signature, the ICA certificate, and the Root CA certificate to establish the chain of trust comprises extracting the firmware and the digital signature comprising the cryptographic hash from the signed firmware package, recomputing the cryptographic hash of the firmware using the SHA-256, verifying the digital signature using the public key included in the signed firmware package, validating the ICA certificate using the Root CA certificate, and validating the root CA certificate using a Root CA public key, where the Root CA public key is stored in the device during factory provisioning.

In some embodiments, sending the signed firmware package comprises sending the signed firmware package to the device via one or more channels such as over-the-air (OTA) updates, physical media, or factory provisioning.

In some embodiments, the signed firmware package comprises a timestamp ensuring the firmware being valid within a defined time window.

In some embodiments, the method further comprises periodically updating the ICA certificate and the signing key pair to enhance cryptographic security while maintaining compatibility with existing devices.

In some embodiments, creating the signed firmware package further comprises compiling the firmware into an executable binary format, and generating the cryptographic hash of the firmware using the SHA-256.

In some embodiments, signing the cryptographic hash based on the private key to generate the digital signature comprises digitally signing the cryptographic hash using the private key and generating the digital signature using an Elliptic Curve Digital Signature Algorithm (ECDSA).

In some embodiments, the signed firmware package is a Cryptographic Message Syntax (CMS) format package.

In some embodiments, the method further comprises storing the Root CA certificate and a predefined regular expression (regex) pattern in a storage medium to ensure secure and tamper-proof storage.

In some embodiments, the predefined regex pattern validates at least one of a Common Name (CN), an Organizational Unit (OU), or a unique product-specific identifier.

In some embodiments, the method further comprises enabling auditing of unauthorized or tampered updates of the firmware if verification of the signed firmware package by the device logs failed attempts to verify the firmware.

In some embodiments, the Root CA certificate stored in the storage medium is periodically verified for expiration or revocation status during the firmware verification.

In some embodiments, the method further comprises rejecting the firmware if the verification of the signed firmware package fails and reverting to a safe operational state using the last verified firmware.

In some embodiments, the firmware includes a unique product-specific identifier embedded within a signer certificate to ensure compatibility with the device.

In yet another embodiment, a system for securing firmware is disclosed. The system comprises a Public Key Infrastructure (PKI) server, a build server, and a device. The PKI server is configured to generate a cryptographic package comprising a root Certificate Authority (Root CA) certificate, an intermediate Certificate Authority (ICA) certificate associated with the Root CA, and a signing key pair comprising a private key and a corresponding public key. The build server is configured to create a signed firmware package based on the cryptographic package and the firmware to be installed on a device, where the build server configured to create the signed firmware package is further configured to generate a cryptographic hash of the firmware, sign the cryptographic hash based on the private key to generate a digital signature, and package the firmware, the digital signature, the ICA certificate, and the Root CA certificate into the signed firmware package, and send the signed firmware package to the device.

The device is configured to verify the signed firmware package by the device, comprising validating the digital signature, the ICA certificate, and the Root CA certificate to establish a chain of trust, and authenticating the firmware using the digital signature and the cryptographic hash.

In some embodiments, the PKI server configured to generate the cryptographic package is further configured to generate the Root CA certificate to serve as a trust anchor, generate the ICA certificate signed by the Root CA certificate, and create the signing key pair comprising the private key for signing operations and the corresponding public key for verification.

In some embodiments, the cryptographic hash is generated based on a Secure Hash Algorithm-256 (SHA-256).

In yet another embodiment, a non-transitory computer-readable medium having stored thereon computer-readable instructions is disclosed. The computer-readable instructions, when executed by a processor, cause the processor to execute a method for securing a firmware. The method comprises generating a cryptographic package comprising a root Certificate Authority (Root CA) certificate, an intermediate Certificate Authority (ICA) certificate associated with the Root CA, and a signing key pair comprising a private key and a corresponding public key.

The method further comprises creating a signed firmware package based on the cryptographic package and the firmware to be installed on a device, where creating the signed firmware package comprises generating a cryptographic hash of the firmware, signing the cryptographic hash based on the private key to generate a digital signature, and packaging the firmware, the digital signature, the ICA certificate, and the Root CA certificate into the signed firmware package, sending the signed firmware package to the device, and verifying the signed firmware package by the device, comprising validating the digital signature, the ICA certificate, and the Root CA certificate to establish a chain of trust; and authenticating the firmware using the digital signature and the cryptographic hash.

The present disclosure is designed to adapt to evolving technological environments. By allowing for updates to ICAs and signing key generation processes, the system ensures continued operability and robustness without requiring fundamental architectural changes. Combining cryptographic techniques with regex-based validation ensures multi-layered security. The inclusion of immutable storage for critical components prevents tampering, while the regex validation adds an additional context-aware verification layer, mitigating potential risks associated with certificate spoofing.

The hierarchical PKI framework and tree-based certificate chain validation ensure that firmware authenticity and integrity are maintained under all circumstances. The use of the CMS format facilitates secure and standardized message encapsulation, reducing vulnerabilities during firmware delivery.

The system uses cryptographic protocols such as CMS and ECDSA, enabling seamless integration with existing security infrastructures. This enhances compatibility across diverse platforms and devices, reducing implementation complexity. The disclosure is well-suited for large-scale deployments across multiple product lines. The use of product-specific regex patterns ensures precise validation for diverse devices without compromising efficiency or accuracy.

Automating the validation process with regex-based matching reduces the need for manual oversight and error-prone operations. This streamlines firmware update workflows, ensuring timely and secure updates.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 depicts a block diagram of a data processing environment configured for firmware security according to an embodiment of the disclosure;

FIG. 2 depicts a block diagram of a computing environment according to an embodiment of the disclosure;

FIG. 3(a)-(b) illustrates a secure Cryptographic Message Syntax (CMS) code signing and verification workflow according to an embodiment of the disclosure;

FIG. 4 illustrates a method for securing firmware according to an embodiment of the disclosure;

FIG. 5 illustrates a system for securing firmware according to an embodiment of the disclosure;

FIG. 6 illustrates another system for securing firmware according to an embodiment of the disclosure; and

FIG. 7 illustrates a schematic diagram of another communication apparatus 700 according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

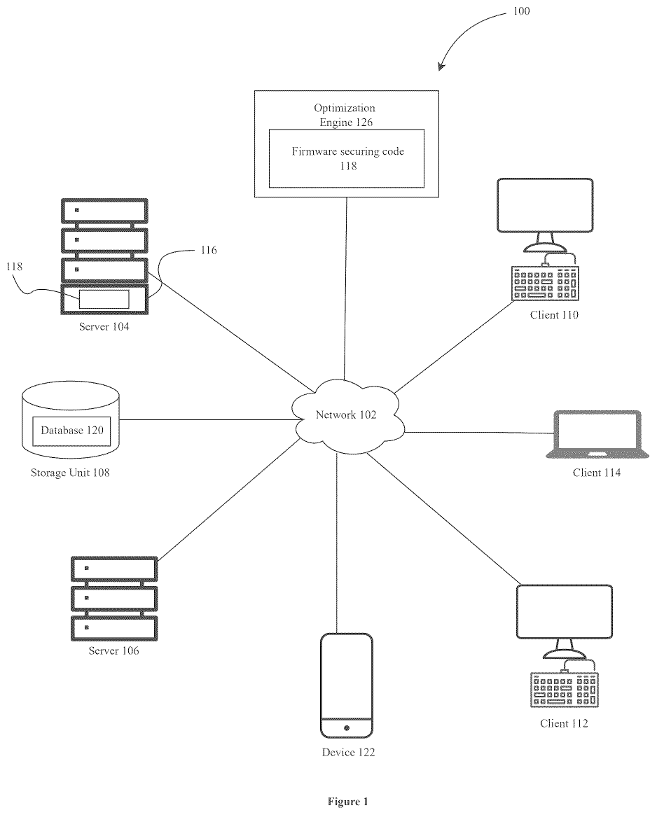

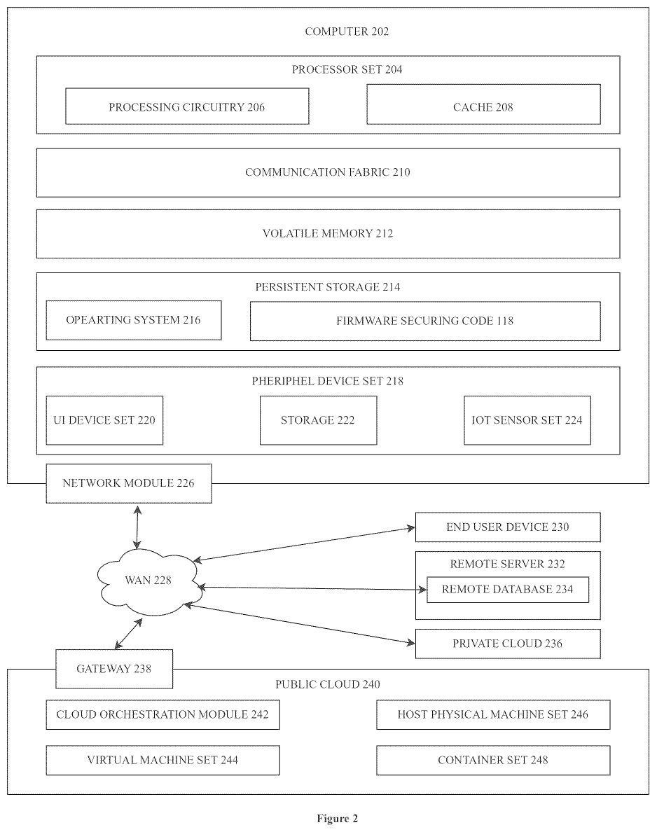

FIG. 1 depicts a block diagram of a data processing environment configured for firmware security according to an embodiment of the disclosure. The data processing environment 100 is a network of computers in which the illustrative embodiments may be implemented. Data processing environment 100 includes network 102. Network 102 is the medium used to provide communications links between various devices and computers connected within the data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 coupled to network 102 along with storage unit 108. Software applications may execute on any computer in data processing environment 100. Client 110, Client 112, Client 114 are also coupled to network 102. A data processing system, such as clients (client 110, client 112, client 114), Optimization Engine 126, and device 122, may include data and may have software applications or software tools executing thereon. Server 104 and server 106 may include one or more GPUs (graphics processing units) for statistical analysis or machine learning.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system, which are all within the scope of the illustrative embodiments.

Data processing systems (optimization engine 126, server 104, server 106, client 110, client 112, client 114, and device 122) also represent example nodes in a cluster, partitions, and other configurations suitable for implementing an embodiment.

Server 104, server 106, storage unit 108, client 110, client 112, client 114, device 122, optimization engine 126 may couple to network 102 using wired connections, wireless communication protocols, or other suitable data connectivity. Client 110, Client 112, and Client 114 may be, for example, personal computers or network computers.

In the depicted example, the servers may provide data, such as boot files, operating system images, and applications to client 110, client 112, and client 114. Client 110, Client 112, and Client 114 may be clients to servers in this example. Client 110, Client 112, and Client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Server application 116, client application 124 and/or optimization engine 126 may include firmware securing code 118, configured for dynamically reconfiguring manufacturing workflows based on user input and market trends. In some embodiments, optimization engine 126 may be or form a part of a server or client described herein.

Device 122 is an example of a device described herein. For example, device 122 can take the form of a smartphone, a tablet computer, a laptop computer, client 110 in a stationary or a portable form, or any other suitable device. Any software application described as executing in another data processing system in FIG. 1 can be configured to execute in device 122 in a similar manner. Any data or information stored or produced in another data processing system in FIG. 1 can be configured to be stored or produced in device 122 in a similar manner. Database 120 of storage unit 108 may store one or more term data samples for computations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as firmware securing code 118. In addition to firmware securing code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and firmware securing code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in firmware securing code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in firmware securing code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game Controller 308s, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer, and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

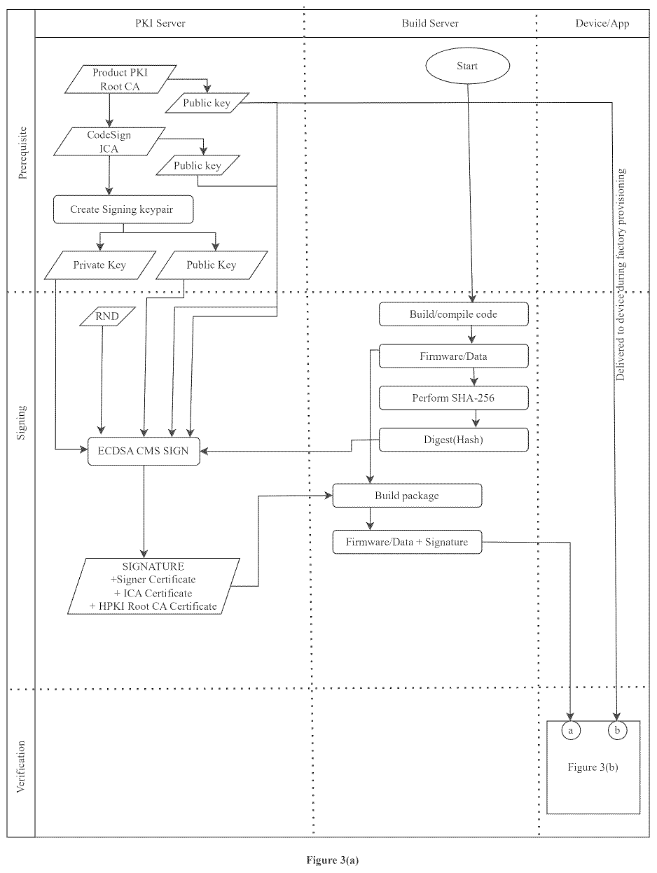

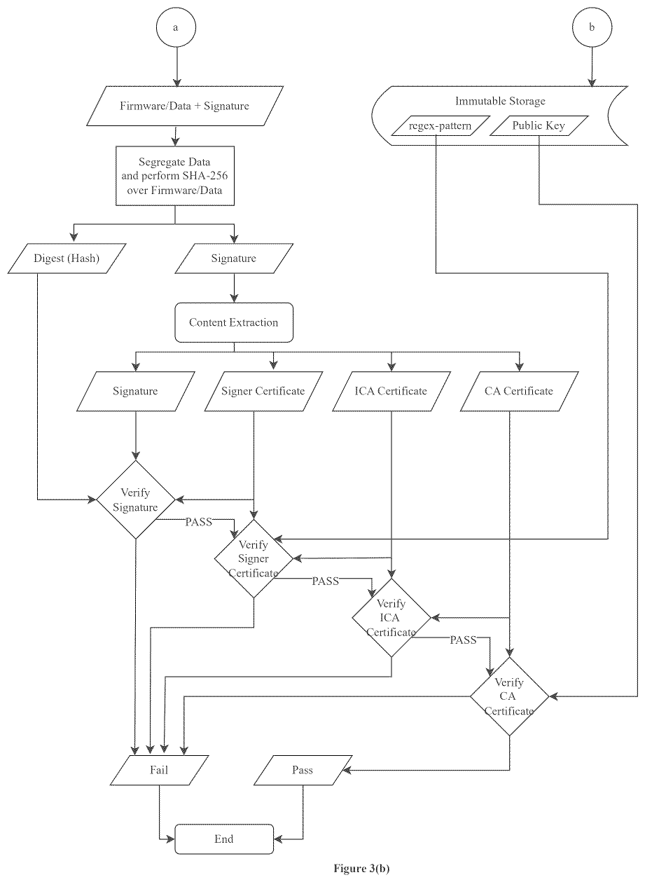

FIG. 3 (a)-(b) illustrates a secure Cryptographic Message Syntax (CMS) code signing and verification workflow according to an embodiment of the disclosure. The disclosed workflow provides a methodology for ensuring data integrity and authenticity through cryptographic principles. The workflow is used in a system which is structured around three key entities a Public Key Infrastructure (PKI) server, a build server, and a device/app. Each component performs steps pertaining to signing, distributing, and verifying firmware/data.

The PKI Server acts as the foundation for generating cryptographic keys and certificates, which includes root certificate authority (Root CA) creation, codesign Intermediate Certificate Authority (ICA), and signing key pair generation.

The Root CA creation includes generating the Root CA, which serves as the trust anchor for the entire PKI infrastructure. The public key is embedded into the Root CA certificate and distributed for use in the verification process.

The Codesign ICA plays a pivotal role in maintaining the security and flexibility of the cryptographic infrastructure. It is responsible for generating intermediate certificates, which are used to issue signing certificates for specific products or applications. This hierarchical segmentation is a critical security measure designed to shield the Root CA from unnecessary and frequent exposure during the signing process. By limiting the involvement of the Root CA, the system significantly reduces the risk of compromise while preserving the overall integrity and trustworthiness of the certificate chain. The ICA certificate itself contains a public key associated with the intermediate authority and is securely signed by the Root CA, establishing a robust chain of trust from the Root CA to the signing certificates.

In the signing key pair generation, a cryptographic key pair (private and public keys) is generated. The private key is securely stored in a hardware security module (HSM) or an equivalent secure environment, while the public key is shared for signature verification.

Further, the build server manages code preparation, signing, and packaging for distribution, including a start process, build/compile firmware, generate SHA-256 digest, ECDSA CMS signing, and build and package firmware.

In the start process, the signing procedure is initiated, triggering subsequent build and cryptographic operations. Further, the build/compile firmware converts the source code into machine-readable binary or firmware form.

Further, a SHA-256 cryptographic hash of the firmware is computed, producing a unique digest that represents the data. This ensures integrity by detecting tampering during verification. In the ECDSA CMS signing, the hash is signed using the ECDSA algorithm with the generated private key. A CMS package is created, encapsulating the digital signature, the ICA certificate, and the Root CA certificate. Incorporating randomness ensures that the signatures are resistant to cryptanalysis.

Further, the build and package firmware include the firmware/data, along with its digital signature and certificates, bundled into a deployable package.

In the verification process, the device performs multiple verification steps upon receiving the signed package. The device performs the following steps storage in immutable medium, extract firmware/data and signature, perform SHA-256 hashing, signature and certificate verification, and verification outcome.

For storing in the immutable medium, during factory provisioning, the device is configured with the Root CA public certificate stored in immutable memory to prevent tampering, and a regex pattern for validating attributes in incoming certificates (e.g., CN or OU fields). For extracting the firmware/data and signature, the device segregates the firmware/data from the signature and accompanying certificates.

For performing the SHA-256 hashing, the device recalculates the SHA-256 hash of the firmware/data to ensure it matches the received hash.

In the signature and certificate verification, the following verifications are performed to establish a chain of trust including signature validation, signer certificate validation, ICA certificate validation, and Root CA validation.

The signature validation step verifies that the digital signature was created using the private key corresponding to the signer's public key. Further, the step confirms that the hash matches the one signed during the CMS signing process.

The signer certificate validation ensures the signer's certificate matches the regex pattern for specified fields and confirms it is valid and has not expired. The ICA certificate validation ensures that the ICA certificate was signed by the Root CA, which establishes a chain of trust.

The Root CA validation confirms that the Root CA certificate is stored securely on the device and serves as the trust anchor. If all checks succeed, the firmware/data is deemed authentic, and the device updates or reboots accordingly. Any failure results in rejecting the firmware/data, ensuring the device's integrity is maintained.

An embodiment includes factory provisioning, during initial setup, the device is preloaded with the Root CA certificate and regex patterns to ensure compatibility and trustworthiness from the outset.

According to an embodiment, the distribution of signed packages includes the signed firmware delivered to devices via secure methods, including OTA updates or physical media. The multi-layered verification process ensures a robust chain of trust, mitigating risks of unauthorized firmware alterations.

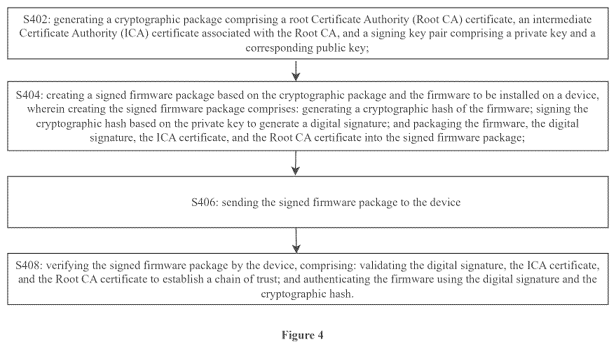

FIG. 4 illustrates a method for securing firmware according to an embodiment of the disclosure, which involves generating cryptographic packages, creating signed firmware packages, transmitting them to a device, and verifying them to ensure security and authenticity. The method establishes a chain of trust using cryptographic certificates and digital signatures, thereby ensuring firmware integrity, and preventing unauthorized modifications.

Step S402 involves generating the cryptographic package, which serves as the cornerstone for establishing a secure and trusted firmware verification framework. This step includes creating a Root Certificate Authority (Root CA) certificate, an Intermediate Certificate Authority (ICA) certificate, and a signing key pair, each playing a critical role in the chain of trust within the Public Key Infrastructure (PKI).

The Root CA certificate functions as the ultimate trust anchor of the PKI, providing the foundational layer for the hierarchical trust structure. It is meticulously generated and securely stored to ensure the integrity and reliability of the overall trust model. Acting as the root of the certificate hierarchy, the Root CA certificate validates the authenticity of all subsequent certificates within the system. Its secure storage is critical to preventing unauthorized access or compromise, as its integrity underpins the security of the entire cryptographic framework.

The ICA certificate is generated in association with the Root CA certificate and is signed by the Root CA to establish a hierarchical trust model. This intermediate certificate plays a pivotal role in extending the trust established by the Root CA to the signer certificates used for firmware signing. By acting as an intermediary, the ICA certificate allows for scalability and facilitates the delegation of signing authority without compromising the Root CA's security. It is used to issue and verify signer certificates, ensuring that only authorized entities can generate firmware signatures, thereby bolstering the trustworthiness of firmware updates.

The signing key pair comprises a private key and a corresponding public key. The private key is securely generated and used exclusively for signing operations, ensuring that only authorized firmware is signed and distributed. Conversely, the public key, included within the cryptographic package, is used to verify the digital signature of the firmware. This asymmetric cryptographic approach provides a robust mechanism for ensuring the authenticity and integrity of firmware updates, as only the corresponding private key can generate the valid digital signature that matches the public key.

In some embodiments, the generation of the cryptographic package is a multi-step process. It begins with creating the Root CA certificate, followed by the generation of the ICA certificate, which is signed by the Root CA to establish the hierarchical trust model. Subsequently, the signing key pair is securely created, with the private key safeguarded against unauthorized access and the public key integrated into the cryptographic package. Each component is generated and stored in adherence to stringent security protocols to maintain the trust chain's integrity. This comprehensive approach ensures that the cryptographic package is robust, secure, and capable of supporting trusted firmware verification and authentication processes.

The cryptographic package generation includes several critical components essential for establishing a secure and trusted environment. In an embodiment, the cryptographic package comprises three key elements: the Root Certificate Authority (Root CA) certificate, the Intermediate Certificate Authority (ICA) certificate, and a signing key pair.

The Root CA certificate serves as the primary trust anchor within the Public Key Infrastructure (PKI), forming the foundation for the entire chain of trust. It is generated through a secure process, ensuring its authenticity and integrity. The Root CA certificate is stored in a highly secure manner to prevent unauthorized access or tampering, preserving the overall reliability of the trust chain. As the anchor of the PKI, the Root CA certificate is pivotal in ensuring that the certificates issued downstream maintain a high level of security.

The Intermediate Certificate Authority (ICA) certificate is directly associated with the Root CA certificate. It's signed by the Root CA, establishing a hierarchical trust model that facilitates the verification and issuance of additional certificates. The ICA acts as an intermediary authority, which allows for greater flexibility and scalability within the PKI. The ICA certificate is primarily used to issue and validate signer certificates that are critical for firmware signing operations, ensuring the integrity of the firmware, and protecting against unauthorized modifications.

The signing key pair consists of two components: a private key and a corresponding public key. The private key is securely stored and used for signing operations, which involve generating cryptographic signatures that prove the authenticity and integrity of the signed data or firmware. The public key, which is made publicly available, allows others to verify the signature, ensuring that the data or firmware has not been altered in transit. This asymmetric key pair system is fundamental for maintaining trust and verifying the legitimacy of the signed content.

In certain embodiments, the process of generating the cryptographic package includes the creation of the Root CA certificate, the generation of the ICA certificate signed by the Root CA, and the secure generation of the signing key pair. The entire process is designed to ensure that each component of the cryptographic package is securely generated and properly linked, maintaining the integrity and trustworthiness of the system.

At step S404, the method comprises creating the signed firmware package. This step involves combining the cryptographic package with the firmware to create a signed firmware package. The process includes generating a cryptographic hash, signing the hash, and packaging.

A cryptographic hash of the firmware is computed using the Secure Hash Algorithm-256 (SHA-256). Further, the computed hash is signed using the private key from the signing key pair. In some embodiments, the Elliptic Curve Digital Signature Algorithm (ECDSA) is used to generate the digital signature. The signed firmware package comprises the firmware, the digital signature, the ICA certificate, and the Root CA certificate.

In some embodiments, the firmware is compiled into an executable binary format before generating the cryptographic hash. The signed firmware package is formatted in the Cryptographic Message Syntax (CMS) format. A timestamp is included in the package to ensure the firmware's validity within a defined time window.

The signed firmware package creation is a critical process for ensuring the integrity and authenticity of the firmware. This step combines the previously generated cryptographic package with the firmware itself to produce a signed firmware package. The process of creating the signed firmware package includes several sub-steps, such as generating a cryptographic hash of the firmware, signing the hash to create a digital signature, and finally packaging the components together in a secure and standardized format.

To begin, a cryptographic hash of the firmware is computed using a secure hashing algorithm, specifically the Secure Hash Algorithm-256 (SHA-256). This algorithm generates a fixed-length hash value that uniquely represents the firmware content. The hash serves as a fingerprint of the firmware, ensuring that even the smallest alteration to the firmware would result in a completely different hash value, making it easy to detect any tampering. Once the hash is computed, it is signed using the private key from the signing key pair. The private key, securely stored and protected, is used in conjunction with a signing algorithm to create a digital signature. In some embodiments, the Elliptic Curve Digital Signature Algorithm (ECDSA) is employed for this task due to its efficiency and strong security properties. The resulting digital signature proves that the firmware has not been altered and that it originates from a trusted source.

The signed firmware package consists of multiple components including the firmware itself, the digital signature, the ICA certificate, and the Root CA certificate. These components are packaged together to ensure that all relevant information needed to verify the authenticity of the firmware is included. The ICA and Root CA certificates are included in the signed firmware package to allow the recipient to trace the chain of trust back to the trusted Root CA, providing assurance that the firmware was signed by an authorized entity.

In certain embodiments, the firmware is compiled into an executable binary format before the cryptographic hash is generated. This binary format is optimized for execution on the target hardware, ensuring that the firmware can be reliably deployed. The signed firmware package is then formatted using the Cryptographic Message Syntax (CMS) format, a widely adopted standard for securely encapsulating cryptographic data. Additionally, a timestamp is included in the signed firmware package to establish a validity period for the firmware, ensuring that it is considered valid only within a defined time window. This timestamp helps prevent issues related to outdated or expired firmware, further enhancing the security and trustworthiness of the firmware distribution process.

At step S406, the method comprises transmitting the signed firmware package. The signed firmware package is transmitted to the target device through various channels, including Over-the-Air (OTA) updates, physical media, and factory provisioning. The OTA Updates ensure remote delivery of the firmware. The physical media provides an alternative for offline installations. Factory Provisioning preloads the signed firmware package onto the device during manufacturing.

At step S408, the method comprises verifying the signed firmware package. Once received, the device verifies the authenticity and integrity of the signed firmware package through the following steps extraction, recomputing the hash, validating the digital signature, certificate validation and chain of trust. In the extraction, the firmware and digital signature are extracted from the package. The cryptographic hash and certificates (ICA and Root CA) are also extracted.

For recomputing the hash, the device computes the SHA-256 hash of the firmware to ensure its integrity.

For validation of the digital signature, the digital signature is verified using the public key included in the signed firmware package. The ICA certificate is validated using the Root CA certificate. The Root CA certificate is validated using the Root CA public key stored in the device during factory provisioning.

The chain of trust establishing the chain of trust ensures that the firmware originates from a legitimate source.

In an embodiment, the ICA certificate and signing key pair are periodically updated to enhance security while maintaining backward compatibility. In another embodiment, the Root CA certificate, and a predefined regular expression (regex) pattern are stored in an immutable storage medium to ensure tamper-proof storage.

The regex pattern validates attributes such as Common Name (CN), Organizational Unit (OU), or unique product-specific identifiers in the signer certificate. Unauthorized or tampered firmware updates trigger logging mechanisms to record failed verification attempts, enabling auditing. If the verification fails, the device rejects the firmware and reverts to the last verified firmware, ensuring operational safety. The firmware includes a unique product-specific identifier embedded within the signer certificate, ensuring compatibility with the target device.

This method ensures the secure distribution and verification of firmware using a robust cryptographic framework. By combining elements like digital signatures, hierarchical certificates, and secure hashing algorithms, provides a reliable mechanism to protect devices against unauthorized firmware modifications and ensures their operational integrity.

In another embodiment, in step S406, the method involves transmitting the signed firmware package to the target device through multiple distribution channels, ensuring that the firmware reaches the device in a secure and reliable manner. These channels include Over-the-Air (OTA) updates, physical media, and factory provisioning. OTA updates provide a flexible, remote method for delivering firmware updates, allowing for seamless updates to devices in the field without the need for physical interaction. Physical media, such as USB drives or external storage, offers an alternative for devices that may not have network connectivity or require offline installations. Factory provisioning involves preloading the signed firmware package onto the device during the manufacturing process, ensuring that the device is ready with the necessary firmware as soon as it is powered on.

In another embodiment, in step S408, the method involves verifying the signed firmware package once it is received by the target device. This verification process is essential to ensure both the authenticity and integrity of the firmware. The verification process includes several steps, such as extracting the firmware and digital signature, recomputing the cryptographic hash, validating the digital signature, performing certificate validation, and ensuring the chain of trust is intact. In the extraction step, the device separates the firmware and digital signature from the signed firmware package, also extracting the cryptographic hash and the certificates (ICA and Root CA) associated with the package.

In another embodiment, in the step of recomputing the hash, the device computes the SHA-256 hash of the extracted firmware. This step ensures that the firmware has not been altered since it was signed, as any modification to the firmware would result in a different hash value. By comparing the recomputed hash with the original hash from the package, the device verifies that the integrity of the firmware is intact.

In another embodiment, during the validation of the digital signature, the device uses the public key that is included in the signed firmware package to verify the authenticity of the digital signature. This ensures that the firmware was indeed signed by the trusted entity and has not been tampered with. The ICA certificate, which links the signer to the Root CA, is validated using the Root CA certificate. This certificate is checked by the device using the Root CA public key, which is securely stored in the device during factory provisioning. This process ensures that the certificates are valid, and that the firmware originates from a legitimate source.

The chain of trust is a crucial element in this verification process. It ensures that the firmware comes from a trusted source by validating the series of certificates that link the signing entity back to the Root CA. By following the chain of trust, the device can confirm that the firmware has not been tampered with and is from a verified, legitimate origin.

In some embodiments, the ICA certificate and signing key pair are periodically updated to enhance the security of the firmware update process while maintaining backward compatibility with devices that may still be using older certificates. In other embodiments, the Root CA certificate, along with a predefined regular expression (regex) pattern, is stored in an immutable storage medium, ensuring that these critical elements are tamper-proof and secure. The regex pattern is used to validate attributes of the signer certificate, such as the Common Name (CN), Organizational Unit (OU), or unique product-specific identifiers, ensuring that the certificate is legitimate and relevant to the device in question.

Unauthorized or tampered firmware updates trigger logging mechanisms within the device. These logs record failed verification attempts, providing a detailed audit trail for security monitoring. If the verification process fails, the device rejects the firmware and reverts to the last verified, safe firmware version, ensuring that the device remains operational and secure. Additionally, the firmware package includes a unique product-specific identifier embedded within the signer certificate, which ensures compatibility between the firmware and the target device.

This method establishes a secure and robust mechanism for the distribution and verification of firmware. By leveraging a combination of cryptographic techniques, including digital signatures, hierarchical certificate structures, secure hashing algorithms, and strict certificate validation, the method provides a reliable framework to protect devices from unauthorized firmware modifications. It ensures that devices only run legitimate, verified firmware, maintaining their operational integrity, and safeguarding them from potential security threats.

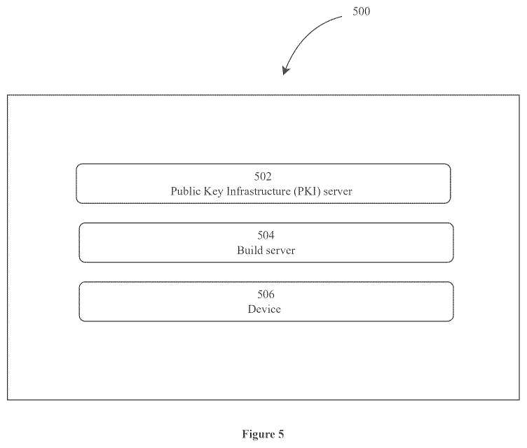

FIG. 5 illustrates a system for securing firmware according to an embodiment of the disclosure. The system includes three core components a Public Key Infrastructure (PKI) server 502, a build server 504, and a device 506, which collectively implement a secure firmware process to ensure the integrity, authenticity, and trustworthiness of firmware updates.

The PKI server 502 generates a cryptographic package that forms the foundation for secure firmware operations. This package includes a Root Certificate Authority (Root CA) certificate that acts as the trust anchor, an Intermediate Certificate Authority (ICA) certificate signed by the Root CA, and a signing key pair comprising a private key for signing operations and a public key for verification. In some embodiments, the PKI server 502 is also configured to generate the Root CA certificate, create the ICA certificate signed by the Root CA, and produce the signing key pair to enable secure signing and verification.

The build server 504 is responsible for creating a signed firmware package based on the cryptographic package and the firmware to be installed on the device 506. This involves generating a cryptographic hash of the firmware using Secure Hash Algorithm-256 (SHA-256), signing the hash with the private key to produce a digital signature, and packaging the firmware, digital signature, ICA certificate, and Root CA certificate into the signed firmware package. The build server 504 then sends this signed package to the target device 506, leveraging various transmission methods, such as over-the-air (OTA) updates or physical media.

The device 506 is configured to verify and authenticate the signed firmware package before installation. This verification process includes validating the digital signature, ICA certificate, and Root CA certificate to establish a chain of trust. It also involves authenticating the firmware by recomputing its cryptographic hash using SHA-256 and comparing it with the signed hash. The device 506 further ensures the trustworthiness of the Root CA certificate using a pre-provisioned Root CA public key.

The system's workflow begins with the PKI server 502 generating the cryptographic package, which includes the Root CA certificate, ICA certificate, and signing key pair. The build server 504 then generates the cryptographic hash of the firmware, signs it uses the private key, and creates a signed firmware package containing the necessary cryptographic elements. This package is delivered to the device 506, which extracts and verifies the firmware and associated cryptographic components. The verification process includes validating the chain of trust from the Root CA certificate to the digital signature and authenticating the firmware by comparing the computed and signed hashes.

In some embodiments, the PKI server 502 enhances its capabilities by generating the Root CA certificate as a trust anchor, creating the ICA certificate signed by the Root CA, and producing secure signing key pairs. The use of SHA-256 ensures strong resistance against cryptographic attacks, and the device 506 validates the chain of trust to guarantee firmware authenticity and integrity.

This system provides robust security for firmware updates, ensuring that only authorized firmware is installed, the firmware's authenticity and integrity are verified, and a strong chain of trust is established from the Root CA to the device 506. By enabling secure firmware delivery, verification, and installation, the system minimizes risks associated with unauthorized or malicious firmware updates.

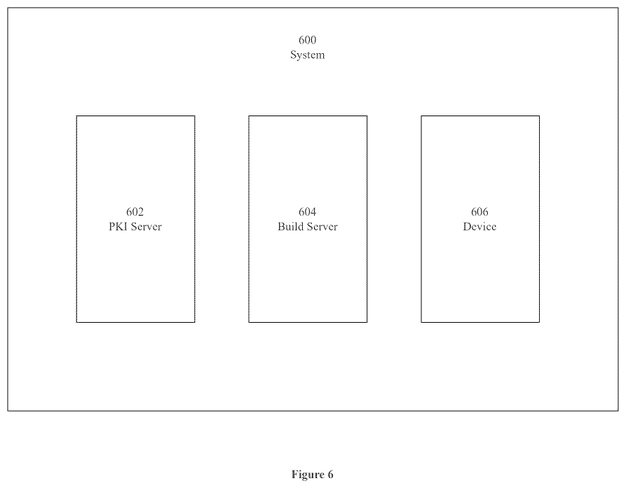

FIG. 6 illustrates a comprehensive system for securing firmware, utilizing a combination of CMS-based cryptographic packaging and regex-based product-specific firmware validation. The system is designed to ensure that firmware updates are both authentic and originate from a trusted source while remaining resilient to potential changes or vulnerabilities in the Intermediate Certificate Authority (ICA) or signing key generation processes. By integrating cryptographic techniques and validation mechanisms, the system helps prevent unauthorized firmware modifications, ensuring the integrity and security of the device.

The proposed system 600 consists of three primary components: the PKI Server 602, the build server 604, and the device 606. These components work together to securely generate, sign, and verify firmware updates. The PKI Server 602 plays a critical role in generating and managing cryptographic keys and certificates, including the Root Certificate Authority (Root CA), the Intermediate Certificate Authority (ICA), and the signer certificates. The build server 604 is responsible for signing the firmware, employing CMS to encapsulate the Root CA, ICA, and signer certificates alongside the firmware package. The device 606, which may be an embedded system or application, is tasked with verifying the signed firmware package using pre-stored Root CA certificates and regex patterns, which are securely stored in immutable storage, ensuring they cannot be tampered with.

The first component of the system, the PKI Server 602 manages several prerequisites for the secure operation of the system, including Root CA generation, ICA generation, and the creation of signing key pairs. These elements are fundamental to establishing a reliable and secure chain of trust.

In the Root CA generation process, the PKI Server 602 generates the Root Certificate Authority (Root CA), which serves as the trust anchor for all subsequent cryptographic operations within the system. The Root CA is securely stored and is the foundation upon which all other certificates are validated. In the ICA generation step, the PKI server derives an Intermediate Certificate Authority (ICA) from the Root CA. The ICA is used to sign product-specific code-signing certificates, helping limit direct exposure of the Root CA and adding an additional layer of security. In the signing key pair creation process, a unique key pair is generated for each product line's firmware. The private key from the signing key pair is used exclusively for signing the firmware, while the corresponding public key is embedded within the signer certificate, allowing for signature verification.

The second component of the system, the build server 604, is responsible for signing the firmware and this process consists of several critical steps, including SHA-256 digest calculation, ECDSA CMS signing, and package creation.

In the SHA-256 digest calculation, the firmware is processed to generate a cryptographic hash using the SHA-256 algorithm. This cryptographic hash serves as a unique fingerprint of the firmware, ensuring that even minor alterations to the firmware would result in a completely different hash, thus enabling tamper detection. In the ECDSA CMS signing step, the SHA-256 digest is signed using the private key from the signer's key pair, producing a digital signature. This signature guarantees that the firmware has not been altered since it was signed. The signature, along with the Root CA, ICA, and signer certificates, is then encapsulated in a CMS-compliant message. Finally, during the package creation step, the signed CMS message is bundled with the firmware, creating a complete and secure firmware update package that can be transmitted to the device.

The final component of the system, the device 606, is responsible for verifying the signed firmware package and ensuring its authenticity and integrity. This process involves two key steps: setting up immutable storage and performing firmware verification.

In the immutable storage setup, the device securely stores the Root CA certificate and regex pattern in an immutable storage medium, such as a Hardware Security Module (HSM) or Trust Zone. This ensures that the device's trust anchors, and validation patterns are protected from tampering, which is crucial for maintaining the system's security.

In the firmware verification process, the device 606 unpacks the firmware package and performs a series of checks to verify the components. These checks include signature validation, certificate chain validation, regex-based validation, and an integrity check.

The signature validation step involves verifying the digital signature using the public key embedded in the signer certificate, ensuring that the firmware has been signed by a legitimate entity. The certificate chain validation process uses the Root CA to validate both the ICA and signer certificates, ensuring that all certificates in the chain are legitimate and properly signed.

The regex-based validation ensures that product-specific attributes, such as Common Name (CN) or Organizational Unit (OU), embedded in the signer certificate, conform to predefined patterns. This validation step helps ensure that the firmware is intended for the correct product line and has not been tampered with. Finally, the integrity check confirms the firmware's integrity by recalculating the SHA-256 hash and comparing it with the original hash contained in the signed firmware package. If all validation steps pass successfully, the firmware is deemed authentic and can be installed on the device. If any check fails, the firmware is rejected, and the device may revert to the last known good version, maintaining its operational integrity and security.

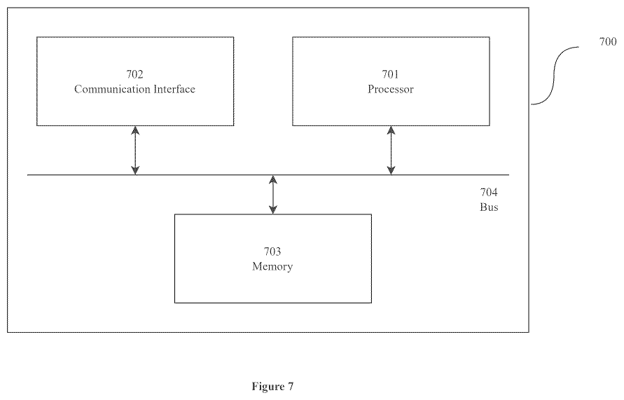

FIG. 7 illustrates a schematic diagram of another communication apparatus 700 according to an embodiment of the disclosure. The communication apparatus 700 includes a processor 701, a communication interface 702, and a memory 703. The processor 701, the communication interface 702, and the memory 703 may be connected to each other via a bus 704. The bus 704 may be a peripheral component interconnect (peripheral component interconnect, PCI) bus, an extended industry standard architecture (extended industry standard architecture, EISA) bus, or the like. The bus 704 may be classified into an address bus, a data bus, a control bus, and the like. For ease of representation, the bus is represented by using only one line in FIG. 4, but it does not indicate that there is only one bus or one type of bus. The processor 701 may be a central processing unit (central processing unit, CPU), a network processor (network processor, NP), or a combination of a CPU and an NP. The processor 701 may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 703 may be a volatile memory or a non-volatile memory or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random-access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may conduct a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for securing a firmware, comprising:
generating a cryptographic package comprising a root Certificate Authority (Root CA) certificate, an intermediate Certificate Authority (ICA) certificate associated with the Root CA, and a signing key pair comprising a private key and a corresponding public key;
creating a signed firmware package based on the cryptographic package and the firmware to be installed on a device, wherein creating the signed firmware package comprises:
generating a cryptographic hash of the firmware;
signing the cryptographic hash based on the private key to generate a digital signature; and
packaging the firmware, the digital signature, the ICA certificate, and the Root CA certificate into the signed firmware package;
sending the signed firmware package to the device; and
verifying the signed firmware package by the device, comprising:
validating the digital signature, the ICA certificate, and the Root CA certificate to establish a chain of trust; and
authenticating the firmware using the digital signature and the cryptographic hash.

2. The method of claim 1, wherein generating the cryptographic package comprises:
generating the Root CA certificate to serve as a trust anchor;
generating the ICA certificate signed by the Root CA certificate; and
creating the signing key pair comprising the private key for signing operations and the corresponding public key for verification.

3. The method of claim 1, wherein the cryptographic hash is generated based on a Secure Hash Algorithm-256 (SHA-256).

4. The method of claim 3, wherein validating the digital signature, the ICA certificate, and the Root CA certificate to establish the chain of trust comprises:
extracting the firmware and the digital signature comprising the cryptographic hash from the signed firmware package;
recomputing the cryptographic hash of the firmware using the SHA-256;
verifying the digital signature using the public key included in the signed firmware package;
validating the ICA certificate using the Root CA certificate; and
validating the root CA certificate using a Root CA public key, wherein the Root CA public key is stored in the device during factory provisioning.

5. The method of claim 1, wherein sending the signed firmware package comprises sending the signed firmware package to the device via one or more channels such as over-the-air (OTA) updates, a physical media, or factory provisioning.

6. The method of claim 1, wherein the signed firmware package comprises a timestamp ensuring the firmware being valid within a defined time window.

7. The method of claim 1, further comprising periodically updating the ICA certificate and the signing key pair to enhance cryptographic security while maintaining compatibility with existing devices.

8. The method of claim 1, wherein creating the signed firmware package further comprises:
compiling the firmware into an executable binary format; and
generating the cryptographic hash of the firmware using the SHA-256.

9. The method of claim 1, wherein signing the cryptographic hash based on the private key to generate the digital signature comprises:
digitally signing the cryptographic hash using the private key and generating the digital signature using an Elliptic Curve Digital Signature Algorithm (ECDSA).

10. The method of claim 1, wherein the signed firmware package is a Cryptographic Message Syntax (CMS) format package.

11. The method of claim 1, further comprising storing the Root CA certificate and a predefined regular expression (regex) pattern in a storage medium to ensure secure and tamper-proof storage.

12. The method of claim 11, wherein the predefined regex pattern validates at least one of a Common Name (CN), an Organizational Unit (OU), or a unique product-specific identifier.

13. The method of claim 1, further comprising enabling auditing of unauthorized or tampered updates of the firmware if verification of the signed firmware package by the device logs failed attempts to verify the firmware.

14. The method of claim 11, wherein the Root CA certificate stored in the storage medium is periodically verified for expiration or revocation status during the firmware verification.

15. The method of claim 1, further comprising rejecting the firmware if the verification of the signed firmware package fails and reverting to a safe operational state using the last verified firmware.

16. The method of claim 1, wherein the firmware includes a unique product-specific identifier embedded within a signer certificate to ensure compatibility with the device.

17. A system, comprising:
a Public Key Infrastructure (PKI) server configured to:
generate a cryptographic package comprising a root Certificate Authority (Root CA) certificate, an intermediate Certificate Authority (ICA) certificate associated with the Root CA, and a signing key pair comprising a private key and a corresponding public key;
a build server configured to:
create a signed firmware package based on the cryptographic package and the firmware to be installed on a device, wherein build server configured to create the signed firmware package is further configured to:
generate a cryptographic hash of the firmware;
sign the cryptographic hash based on the private key to generate a digital signature; and
package the firmware, the digital signature, the ICA certificate, and the Root CA certificate into the signed firmware package; and
send the signed firmware package to the device;
a device configured to:
verify the signed firmware package by the device, comprising:
validating the digital signature, the ICA certificate, and the Root CA certificate to establish a chain of trust; and
authenticating the firmware using the digital signature and the cryptographic hash.

18. The system of claim 17, wherein the PKI server configured to generate the cryptographic package is further configured to:
generate the Root CA certificate to serve as a trust anchor;
generate the ICA certificate signed by the Root CA certificate; and
create the signing key pair comprising the private key for signing operations and the corresponding public key for verification.

19. The system of claim 17, wherein the cryptographic hash is generated based on a Secure Hash Algorithm-256 (SHA-256).

20. A non-transitory computer-readable medium having stored thereon computer-executable instructions that, when executed by a processor, cause the processor to execute a method for securing a firmware, comprising:
generating a cryptographic package comprising a root Certificate Authority (Root CA) certificate, an intermediate Certificate Authority (ICA) certificate associated with the Root CA, and a signing key pair comprising a private key and a corresponding public key;
creating a signed firmware package based on the cryptographic package and the firmware to be installed on a device, wherein creating the signed firmware package comprises:
generating a cryptographic hash of the firmware;
signing the cryptographic hash based on the private key to generate a digital signature; and
packaging the firmware, the digital signature, the ICA certificate, and the Root CA certificate into the signed firmware package;
sending the signed firmware package to the device; and
verifying the signed firmware package by the device, comprising:
validating the digital signature, the ICA certificate, and the Root CA certificate to establish a chain of trust; and
authenticating the firmware using the digital signature and the cryptographic hash.
